(19) United States
(12) Patent Application Publication
(10) Pub. No.: US 2014/0033676 A1
(43) Pub. Date: Feb. 6, 2014

(54) UNIQUE METHOD OF SOLAR INTEGRATION IN COMBINED CYCLE POWER PLANT

(71) Applicants: Raymond PANG, Schenectady, NY (US); Kamlesh Mundra, Clifton Park, NY (US); Nestor Hernandez Sanchez, Schenectady, NY (US)

(72) Inventors: Raymond PANG, Schenectady, NY (US); Kamlesh Mundra, Clifton Park, NY (US); Nestor Hernandez Sanchez, Schenectady, NY (US)

(21) Appl. No.: 13/564,968

(22) Filed: Aug. 2, 2012

(51) Int. Cl. F01K 23/10; F01K 7/16; F03G 6/00; F01K 13/00

(52) U.S. Cl. 60/39.182; 60/772; 60/653; 60/676; 60/641.8

(57) ABSTRACT

A method of integrating a supplemental steam source into a combined cycle plant comprising a gas turbine engine, generator and heat recovery steam generator (HRSG) by providing a solar steam generation subsystem that captures and transfers heat using solar radiation to produce supplemental superheated steam; providing a steam turbine operatively connected to the gas turbine; and injecting a portion of the steam formed by solar radiation into one or more intermediate stages of the high pressure section of the steam turbine. The exemplary method uses steam produced by the HRSG (having one, two or three pressure levels and with or without reheat), as well as steam produced by a solar steam generation subsystem when the plant is operating at full capacity. Significantly, the throttle pressure of the high pressure steam turbine remains substantially the same when the solar steam generation is either active or inactive.

The present invention relates to a new type of a combined cycle gas and steam power plant that includes a gas turbine unit, electrical generator, heat recovery steam generator (“HRSG”), steam turbine, and an integral solar-based steam generation unit that provides supplemental heat which improves the thermal efficiency and electrical output of the combined cycle plant. The invention also relates to a method for operating a combined cycle plant with both a gas turbine and steam turbine where the solar heat is integrated into the combined cycle for effective use in both solar “on” and solar “off” conditions using the new heat transfer configurations and equipment described herein.

### BACKGROUND OF THE INVENTION

Current U.S. and world-wide environmental concerns, as well as an increased demand for energy despite growing hydrocarbon fuel shortages, have prompted the development of new technologies for power plants, particularly hybrid plants capable of using different combinable and/or exchangeable energy sources. In more recent times, gas-fired combined cycle power plants achieve much higher efficiencies compared to coal or oil-fired Rankine cycle plants and normally rely on more than a single thermodynamic cycle to generate turbine power. A typical combined cycle power plant and cogeneration facility uses a gas turbine to generate power based on well known Brayton Cycle principles and typically has high exhaust flows and very high turbine exhaust temperatures. When directed into a heat recovery boiler system such as a heat recovery steam generator (HRSG), the plants produce steam in a separate turbine used to generate additional power and/or provide process steam for other related industrial purposes. The gas turbine produces work via the Brayton Cycle (often called a “topping cycle”) and the steam turbine produces power via the Rankine Cycle (a “bottoming cycle”), thus defining the term “combined cycle.”

Because the efficiency of steam power plants in combined cycle systems (e.g., HRSGs) can be increased by adding steam produced from solar energy, a number of systems have been developed in the past in an effort integrate solar heat into a combined cycle plant. In most solar thermal power plants, the radiation energy of the sun is captured using solar receivers (referred to as “absorbers” or “collectors”) in the form of a plurality of carefully aligned reflectors with surfaces that concentrate the incident sunlight and track the sun's daytime path. As the sun shines, automated positioning mirrors (“heliostats”) align themselves so that the sunlight reflects directly onto a central receiver. The radiation energy is then transmitted into a heat transfer medium such as air, liquid salt or a water/steam process which is then used to generate steam in a steam turbine power plant and ultimately produce electrical power by a generator coupled to the steam turbine.

Various prior attempts to more effectively integrate solar power with combined cycle power plants are known to the art. Most of the solar thermal power currently being produced uses a “parabolic trough” technology consisting of large fields of parabolic trough collectors, a heat transfer fluid/steam generation system, a Rankine steam turbine/generator cycle and some form of fossil-fuel backup system. Normally, the solar field is modular in nature and comprises multiple rows of single-axis-tracking parabolic trough solar collectors aligned along a north-south horizontal axis. Each solar collector includes a parabolic shaped reflector that focuses the sun's radiation on a linear receiver positioned at the parabola focal axis and tracks the sun from east to west during the day. In most such systems, the heat transfer fluid increases in temperature to about 400° C. and is circulated through the receiver and returned to a series of heat exchangers where the solar heat is absorbed by a heat transfer fluid (typically synthetic oil). The heat is then extracted using a combination of evaporators and heat exchangers to generate superheated steam. The steam is thereafter fed to a steam turbine/generator to produce electricity. The expanded steam from the turbine is eventually condensed and the cooled heat transfer fluid re-circulated through the solar field.

As detailed below, the overall time-weighted thermal efficiency levels achieved by the present invention, which are specifically designed to operate in a continuous manner in both solar “on” and “off” conditions, are significantly higher than existing conventional designs. The new method and systems allow for superheated steam generated by the solar energy collection system to be more efficiently integrated into the HRSG and eventually used to drive the steam turbine in the combined cycle plant. The use of solar energy according to the invention serves to reduce the overall amount of hydrocarbon fuel gas (e.g., natural gas) that otherwise must be consumed over time to produce a given electrical output. For example, the invention increases the electrical output of plants relying on a constant fuel flow during peak electrical consumption periods where the economic value of electricity is generally higher (e.g., summer vs. winter months or mid-afternoon vs. overnight). The invention also increases the overall thermal efficiency of the plant without suffering a penalty when the solar steam production is temporarily discontinued (“off”).

In contrast, the following patents and publications exemplify some of the known (but less efficient) solar-based combined cycle systems: U.S. Pat. Nos. 5,444,972, 5,417,052 and publication No. 2006/0260314. The use of supplemental solar energy heat as described below also has the added commercial value in the market of being a “green” energy source which does not sacrifice or inhibit the functionality of the plant itself. In addition, the exemplary solar energy collection systems described herein, because of their basic modular design, can be added to combined cycle plants that are not otherwise used to their fullest production capacity, including those designed and built to operate at higher capacity but reduced in operation due to the increased cost or reduced availability of hydrocarbon fuels needed to operate the gas turbine engine.

### BRIEF DESCRIPTION OF THE INVENTION

The invention described herein includes a method of designing and/or retrofitting a combined cycle power plant in order to efficiently utilize a supplemental steam source (normally superheated) using solar radiation, and then integrating the superheated steam into a combined cycle plant that includes a gas turbine engine, generator, heat recovery steam generator (HRSG) and steam turbine. The new method includes the steps of providing a solar collection subsystem integrated into the HRSG designed to capture and transfer heat using solar radiation and produce the supplemental superheated steam; providing a generator and steam turbine operatively connected to the gas turbine; and injecting a portion of the superheated steam formed by solar radiation directly into an intermediate stage of the high pressure section of the steam turbine.

The method of designing/retrofitting a combined cycle plant takes into account the need to have a steam turbine sufficient in size to utilize all of the superheated steam produced by the HRSG (which can optionally comprise one, two or three steam pressures and may include reheat sections), including the superheated steam produced by the solar collection subsystem, when the entire plant is operating at full capacity. Thus, the invention effectively combines the superheated steam generated by the HRSG with the steam formed by solar radiation. The new method described herein also includes an optional superheater dedicated to solar generated steam that can be integrated into the HRSG under various different operating conditions depending on the thermal properties of the supplemental, solar-generated steam. Significantly, and different from known solar-based systems where solar generated steam is admitted into the high pressure steam turbine, the high pressure throttle pressure remains substantially the same for both “on” and “off” operation of the solar collection subsystem. This provides improved thermodynamic efficiency when the solar collection subsystem is “off” while capturing part of the benefit of admitting steam into the high pressure steam turbine. The invention also includes the designed/retrofitted combined cycle plant itself, including a gas turbine, generator, steam turbine, HRSG and integrated solar collection subsystem.

### BRIEF DESCRIPTION OF THE DRAWINGS

FIG. 1 is a process flow diagram depicting the major pieces of equipment and flow pattern for an exemplary combined cycle plant (including at least a gas turbine, heat recovery steam generator and steam turbine), with the plant being capable of incorporating a solar steam generation subsystem according to the invention;

FIG. 2 is a portion of the general process flow diagram shown in FIG. 1 depicting a known option for using steam generated by an external solar plant (with the relevant flow lines shown in a darker form) which results in a significantly lower overall thermal efficiency of the combined cycle plant as compared to the present invention when the solar steam generation system is “on”;

FIG. 3 depicts a second portion of the general process flow diagram shown in FIG. 1 showing another known option for using steam generated by a solar plant, but again exhibiting a lower thermal efficiency as compared to the process flow configurations of the present invention when the solar steam generation system is “on”;

FIG. 4 shows a third portion of the general process flow diagram of FIG. 1 depicting a third known option for using steam generated by a solar plant. The thermal efficiency may be similar to the present invention while the solar steam generation system is “on,” however the thermal efficiency will be significantly lower compared to the present invention when the solar generation system is “off.”;

FIG. 5 depicts a fourth portion of the general process flow diagram shown in FIG. 1 illustrating yet another known option for using steam generated by a solar plant. The thermal efficiency will generally be higher than the present invention while the solar steam generation system is “on,” however the thermal efficiency will be significantly lower compared to the invention when the solar steam generation system is “off.”;

FIG. 6 is a process flow diagram showing the flow pattern and major pieces of equipment for a first embodiment of the invention using an external solar steam generation plant that yields most of the benefit of solar generated steam admission into the high pressure steam turbine while substantially eliminating the thermal efficiency penalty while the solar steam generation system is “off.”; and

FIG. 7 is a process flow diagram showing the flow pattern and major pieces of equipment for a second embodiment of the invention which also yields most of the benefit of solar generated steam admission into the high pressure steam turbine while substantially eliminating the thermal efficiency penalty while the solar steam generation system is “off.”

### DETAILED DESCRIPTION OF THE INVENTION

As summarized above, the present invention provides a new method and system for improving the efficiency and electrical output of a combined cycle power plant using solar energy and, in particular, to a unique method of using superheated steam produced by a solar energy subsystem that can be integrated into the combined cycle plant via the heat recovery steam generator (HRSG) and results in higher overall plant efficiency while the integrated solar subsystem is “on” while mitigating the efficiency penalty typically observed while the solar subsystem is “off.”

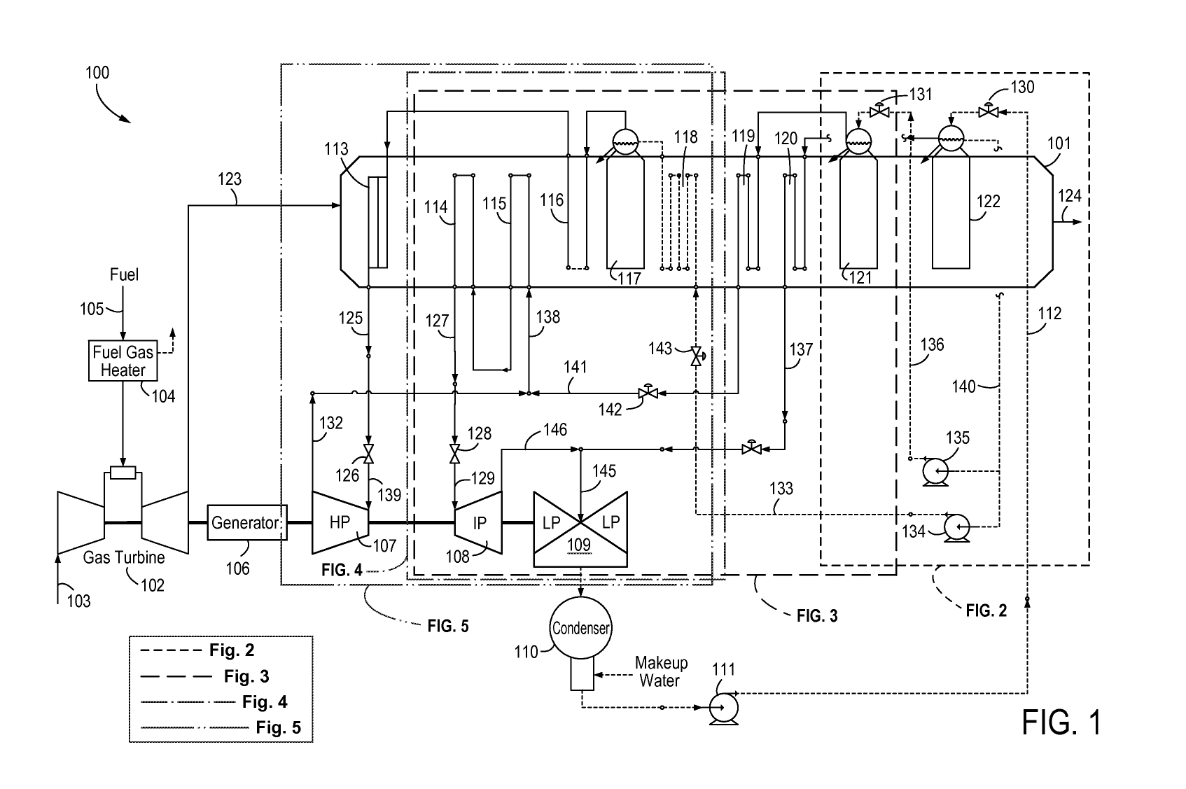

As a general proposition (and as reflected in FIG. 1), the method and system includes at least one gas turbine engine to combust hydrocarbon fuel and generate high temperature exhaust gas; at least one heat recovery steam generator capable of producing superheated steam from the high temperature exhaust gas; an effective heat transfer medium (water and/or steam) integral with the gas turbine and HRSG; a steam turbine operatively connected to the HRSG sized to accommodate the steam generated in the HRSG when both the gas turbine and solar steam generating unit operate at full capacity; a separate “turnkey” solar steam generator unit operatively integrated into the HRSG that captures solar radiation to heat the heat transfer medium (high pressure water) and generate high pressure superheated steam; and steam conveyance means for transporting the solar-generated steam into one or more stages of the high pressure section of the steam turbine.

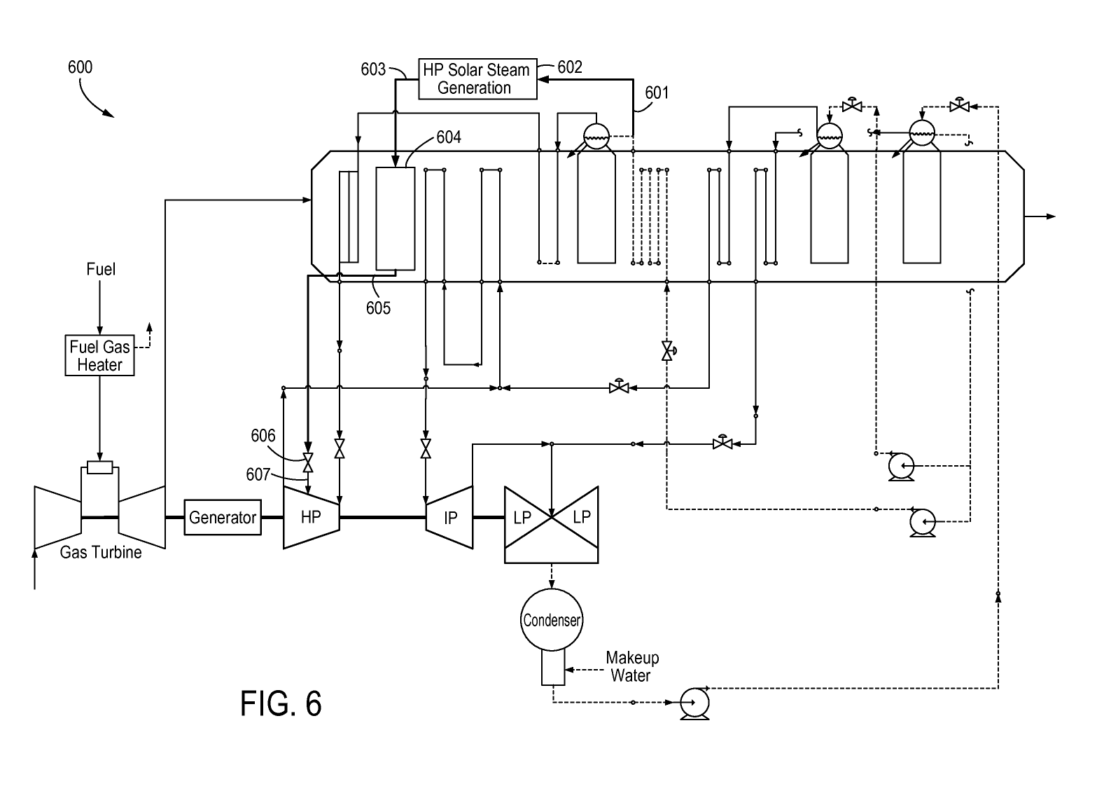

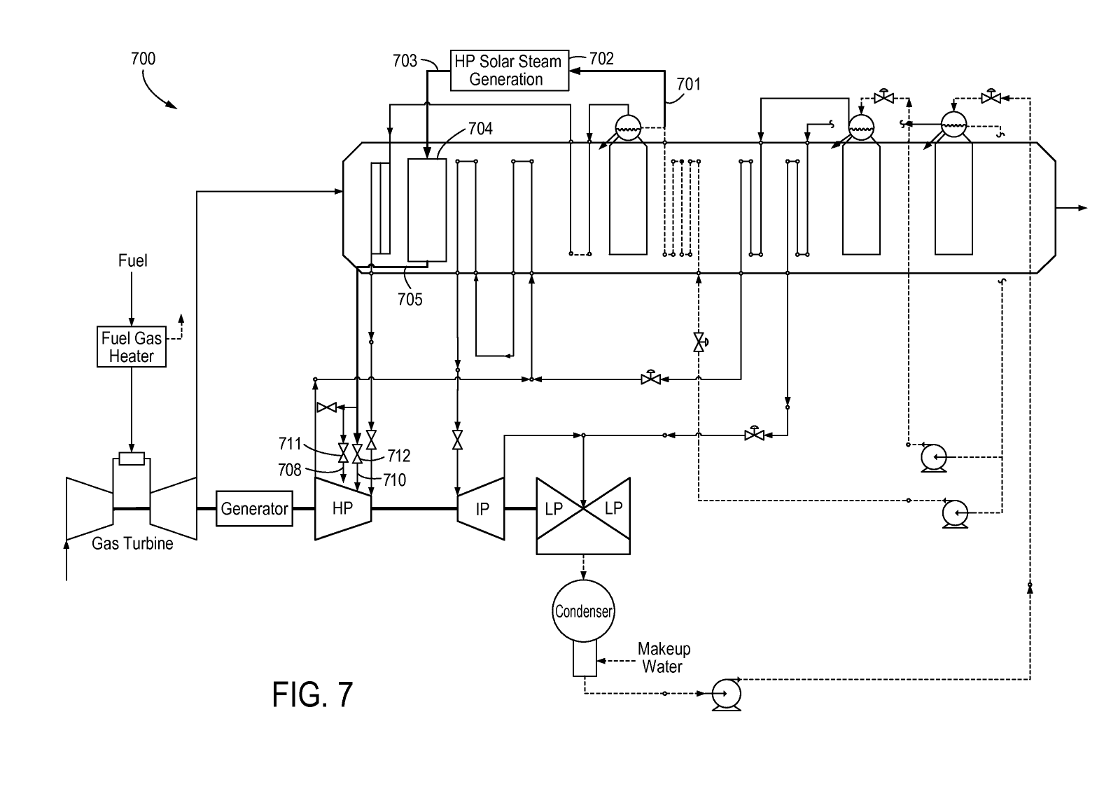

In the exemplary embodiments described herein (e.g., FIGS. 6 and 7), the gas turbine, HRSG, solar steam generator and steam turbine can be an integral part of the original combined cycle plant, i.e., a new hybrid plant. Alternatively, the solar steam generator can be incorporated into an existing combined cycle plant as a retrofitted additional process component. In either case, the combined cycle/steam generating system using solar energy can be operated at different times under different circumstances, for example only during daylight hours when solar energy is available, or under variable conditions if the solar input changes during the day. Further, the use of supplemental heating and solar steam generation is desirable, but not essential, to the existing combined cycle operations. Thus, the system provides a significant efficiency benefit with or without the use of additional solar-generated steam.

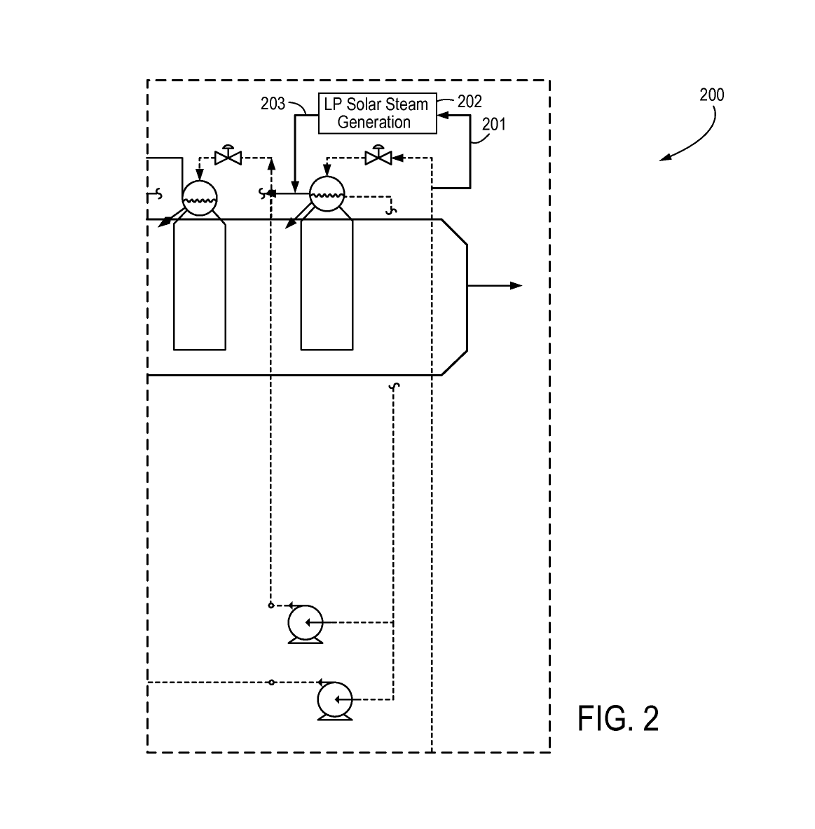

As noted above, various retrofitted solar steam designs have been used in the past to introduce solar steam into either the steam turbine itself or the HRSG. In order to better understand the nature and significance of the invention, those different prior designs are described below and identified as options 1 through 4 in connection with FIGS. 2, 3, 4 and 5. Typically, in the past, the fluid flow from a solar field has been integrated into the low pressure section of the HRSG which is one of the least challenging designs from the standpoint of minimizing changes to the flow pattern in and around the HRSG. However, such low pressure integration designs suffer from relatively low thermodynamic efficiencies because any additional work must be extracted only out of the low pressure section of the steam turbine.

Another known alternative solar integration retrofit merges the steam created by solar heat to the cold reheat section of the HRSG. Again, this alternative exhibits only marginally better efficiency as compared to low pressure integration.

Other attempts have also been made to feed solar-generated steam directly into the high pressure section of the HRSG or into the inlet to the high pressure steam turbine itself. Solar steam admission into the high pressure HRSG section or steam turbine inlet generally provides the highest thermodynamic efficiency when the solar steam generation is active. However, those alternatives will have reduced thermodynamic efficiency compared to each of the other noted alternatives when the solar steam generation system is inactive. Additionally, these options invariably involve challenging and expensive designs for the solar field itself, e.g., the upstream piping and drum/evaporators result in increased manufacturing and maintenance costs.

The invention represents a significant departure from these known solar steam options. By way of summary, superheated solar steam is generated using an external turnkey subsystem which feeds the supplemental superheated steam into the high pressure section of the steam turbine at one or more mid-range pressure stages in the turbine. As such, the system differs significantly from known prior designs that feed steam upstream of the inlet of the high pressure, intermediate or low pressure section of the turbine. The new configuration (e.g, as shown below in FIGS. 6 and 7) also allows for very precise and accurate temperature matching of the solar steam feed into to the turbine by optionally including a superheater section in the HRSG, with the need for the superheater determined by real time operating conditions in the plant (which may change over time or even during the day). In the end, the invention results in a higher overall thermal efficiency of the combined cycle plant while the solar generation subsystem is “on” compared to cold-reheat and low pressure steam admission, without experiencing the efficiency penalty typical of high pressure admission while the solar generation subsystem is “off.” Additionally the lower pressure required for high pressure interstage admission is less challenging and more cost effective to implement compared to other designs using high pressure HRSG or steam turbine throttle admission.

Turning to the figures, FIG. 1 is a general process flow diagram depicting the major pieces of equipment and flow pattern for an exemplary combined cycle plant capable of incorporating a solar steam generation method and system according to the invention. The entire plant is depicted generally at 100 and includes gas turbine engine 102 which operates using air feed 103 feeding into the gas turbine following an air treatment, along with hydrocarbon fuel 105 which passes through fuel gas heater 104 before entering the gas turbine. Gas turbine 102 operatively connects to electrical generator 106 which in turn couples to a steam turbine characterized in FIG. 1 as comprising three separate sections, namely a high pressure (“HP”) turbine section 107, intermediate pressure (“IP”) section 108 and low pressure (“LP”) section 109.

FIG. 1, as well as related FIGS. 2 through 7, all relate to a “single shaft” configuration, i.e., a single gas turbine and only one steam turbine coupled on a single shaft with one generator. However, the present invention is also applicable to “multi shaft” configurations and thus would include two or three gas turbine engines (each connected to its own HRSG and each feeding steam to a single steam turbine). In the multi-shaft configurations, each gas turbine and steam turbine will have its own dedicated generator. Thus, while the drawings and description herein illustrate an exemplary single shaft embodiment, it should be understood that the invention is also applicable to other hybrid/combined cycle configurations including, but not limited to, 2-on-1 multishaft, 3-on-1 multishafts, 4-on-1 multishafts, non-reheat HRSGs, single-flow low pressure steam turbines and similar combined cycle systems.

In FIG. 1, The low pressure discharge from the steam turbine passes into condenser 110 as the primary feed to centrifugal condensate pump 111 (with the pump feed including additional make-up water). Condensate pump 111 is sized to feed the increased pressure condensate 112 into low pressure evaporator 122, with the flow being monitored and controlled via evaporator feed level control valve 130. Low pressure evaporator 122 utilizes a portion of the heat transferred from the gas turbine exhaust to generate high temperature boiler feedwater stream 140, a portion of which feeds into centrifugal high pressure boiler feedwater pumps 134 and 135. The higher pressure discharge 136 from boiler feedwater pump 135 (along with a portion of the boiler feedwater (bfw) from low pressure evaporator 122) feeds directly into intermediate pressure evaporator 121 using level control valve 131 which monitors and controls the amount of feed.

The bfw discharge 133 from boiler feedwater pump 134 passes through level control valve 143 into high pressure economizer 118. From a process design standpoint, high pressure economizer 118 in FIG. 1 can be a conventional heat exchanger, with high temperature water on one side and a portion of gas turbine exhaust as the heating medium on the other side. Saturated steam generated by low pressure evaporator 122 feeds into low pressure superheater 120 and the resulting superheated steam 137 passes through a steam control valve into the low pressure section 109 of the steam turbine as low pressure steam feed 145. Low pressure steam feed 145 combines with the exhaust from the intermediate pressure section 108 of the steam turbine via “cross over” pipe 146.

Meanwhile, saturated steam generated by intermediate pressure evaporator 121 passes into intermediate pressure superheater 119 to become part of a combined feed through control valve 142 and then into reheaters 114 and 115 as shown. The steam feed to reheater 115 also includes steam discharged from high pressure turbine 107 through high pressure steam line 132 which combines with the steam generated by intermediate pressure superheater 119 to form a combined superheated steam feed 138 into reheater 115. Reheated steam 127 can then be fed directly into the intermediate pressure section 108 of the steam turbine using control valve 128 via intermediate pressure feed line 129.

High pressure economizer 118, which operates as a high pressure heat exchanger with water on one side and high temperature exhaust gas on the other side, feeds the boiler water following heating in the economizer into high pressure evaporator 117 to produce very high pressure saturated steam (e.g., nominally as high as 2,400 psi). The saturated high pressure steam passes through high pressure superheater 116 which produces superheated steam, again using heat provided by the gas turbine engine exhaust. The superheated steam then passes through high pressure steam superheater 113. The resulting high pressure superheated steam discharge 125 feeds directly into the highest pressure section 107 of the steam turbine through steam control valve 126 and high pressure injection feed line 139 as indicated.

As FIG. 1 makes clear, in a conventional combined cycle system using an HRSG, the high temperature exhaust gas discharge 123 from gas turbine 102 feeds directly into HRSG 101, which in this embodiment defines a “three pressure reheat” type HRSG that includes high, intermediate and low pressure reheaters as integral parts of the HRSG and combined cycle. In all such three pressure reheat systems, the high temperature exhaust gas from the gas turbine feeds directly into the HRSG as shown and ultimately exits as a relatively low temperature exhaust gas 124.

Significantly, the present invention can be used on HRSGs with three, two, or one pressure levels, and with or without reheat due to the modular nature of the solar-based steam generation unit described herein, depending on the original design and operating characteristics of the HRSG in the combined cycle plant. The feed to the solar steam generation subsystem can also originate from a number of different sources in the plant and still serve to increase the overall efficiency of the system, including, for example, steam from high pressure economizer 118 in FIG. 1 or from lower temperature water sources such as the discharge from condensate pump 111.

The three pressure reheat flow pattern for the HRSG in FIG. 1 thus includes means for reheating high pressure steam in different portions of the HRSG (see reheaters 114 and 115). However, the invention can be used not only in three pressure reheat systems, but also with older two and single pressure reheat systems, or even a no reheat HRSG configuration. Generally speaking, a two pressure reheat system would not include the intermediate pressure HRSG section described above in connection with FIG. 1, but instead rely only on the high pressure and low pressure HRSG sections. A single pressure reheat system would nominally include only a high pressure section without the intermediate pressure and low pressure sections in FIG. 1. A no reheat embodiment would not reheat the high pressure exhaust from the steam turbine but instead feed the exhaust (at approximately 600-700° F.) directly into the intermediate pressure section of the steam turbine.

As also seen in FIG. 1, the intermediate pressure exhaust from the steam turbine feeds into the lower pressure section of the steam turbine through “cross over pipe” 146 to join the discharge from low pressure superheater 120 as a combined steam feed into the low pressure section of the turbine as shown at 145. The various low pressure, intermediate pressure and high pressure evaporators in FIG. 1, items 122, 121 and 117, respectively, all operate using heat from the gas turbine to evaporate their respective high temperature water feeds into saturated steam for discharge at the same corresponding saturated steam temperature. The resulting saturated steam feeds are thereafter superheated in the downstream operations as indicated above.

FIG. 2 of the drawings illustrates a portion of the general process flow diagram shown in FIG. 1 depicting a first known option (shown generally as 200) for using steam generated by an external solar plant (with the relevant flow lines shown in a darker format) and represents a design with a much lower overall thermal efficiency as compared to the present invention. The low pressure steam section depicted in FIG. 2 nominally operates in the range of about 50-150 psi as compared to the intermediate pressure section which operates at about 350-550 psi and the high pressure section at approximately 1,800-2,400 psi. As FIG. 2 shows, steam generated by the solar plant feeds directly into the low pressure section of an HRSG (operating at about 50-100 psi).

This first known option in FIG. 2 evaporates boiler feedwater, superheats the resulting saturated steam after being extracted from a low pressure drum, and introduces the superheated steam directly into to the low pressure section of the HRSG. Although this design appears to be somewhat less challenging from a design perspective and perhaps easier to retrofit into an existing combined cycle plant, it suffers from a number of significant thermal inefficiencies compared to the invention. For example, because the solar-generated steam is only admitted into the low pressure section of the steam turbine (and provides relatively little opportunity for expansion work) the thermal efficiency of the first option is the lowest of the known design options discussed in connection with FIGS. 2 through 5.

With specific reference to the flow configuration in FIG. 2, boiler feedwater stream 201 is taken from the discharge of the low pressure economizer (see FIG. 1) into low pressure solar steam generator 202 which, as indicated above, normally comprises a turnkey integrated solar steam production unit. Low pressure steam generated by the solar energy feeds directly back into the system through supplemental low pressure steam discharge 203 as shown and combines with the steam being generated by low pressure evaporator 122 as described above in connection with FIG. 1.

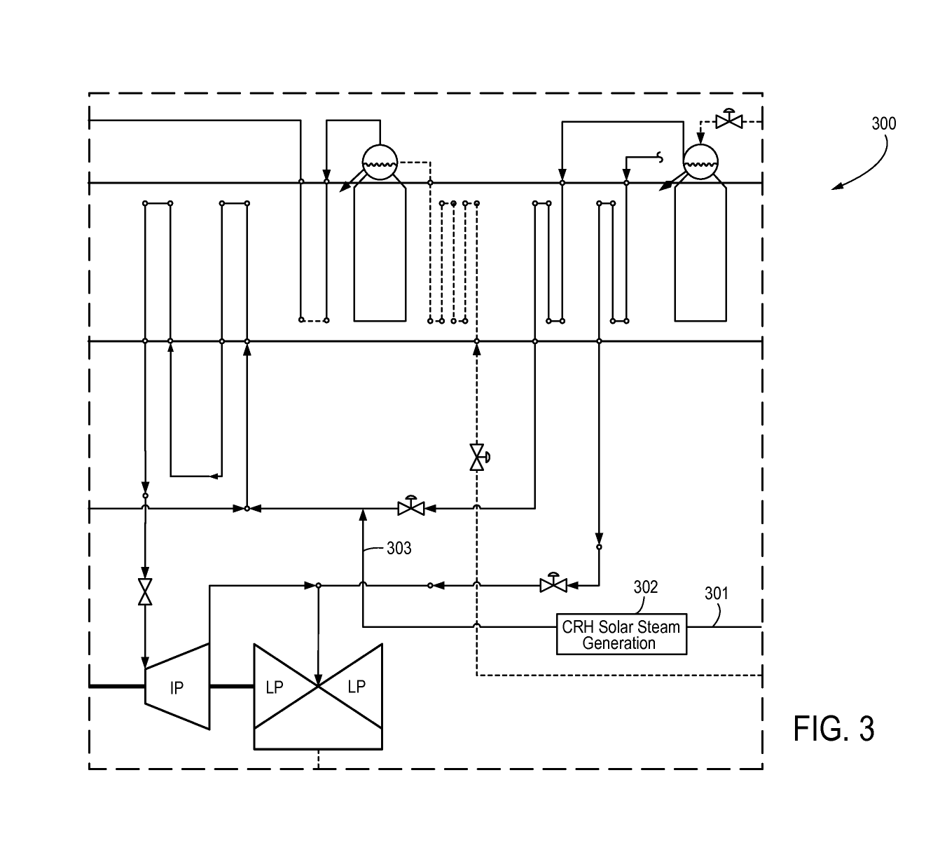

FIG. 3 shows a second isolated portion of the general process flow diagram in FIG. 1 depicting a second known option for using steam generated off site using solar energy and typically known as a “cold reheat steam admission.” The term “cold reheat” as used herein refers to the use of solar energy to evaporate and superheat intermediate pressure feedwater and merge that solar generated steam into the high pressure exhaust stream.

The FIG. 3 flow pattern, shown generally at 300, includes solar steam generator 302 which produces superheated steam 303 using a portion of the boiler feedwater discharge 301 from boiler feedwater pump 134 (see FIG. 1). FIG. 3 also shows that the superheated steam provided by solar steam generator 302 combines with superheated steam provided by intermediate pressure superheater 119 as a single steam feed to reheater 115 (again see FIG. 1).

Notably, the second option depicted in FIG. 3 is similar in principle to the low pressure steam admission shown in FIG. 2 (the first option) and thus likewise suffers from similar thermal inefficiencies and implementation issues. The incremental thermal efficiencies of options 1 and 2 in FIGS. 2 and 3 have been found to be about 35% or below. In contrast to the first option of FIG. 2, the boiler feedwater used in the FIG. 3 option is extracted upstream of an intermediate pressure drum but downstream of an intermediate pressure boiler feedwater pump (operating at about 300-650 psi). The water is then introduced at a point downstream of the high pressure exhaust from the steam turbine but upstream of the reheaters.

The method for introducing supplemental solar-generated steam in FIG. 3 may be more thermally efficient than the low pressure embodiment in FIG. 2 because the solar-generated steam is expanded through both the intermediate and low pressure sections of the steam turbine. However, this second option has proven to be more challenging and costly when implemented in a combined cycle plant due to the higher pressures involved. In addition, introducing the solar-generated steam into the cold reheat piping in FIG. 3 increases the pressure at the intermediate pressure inlet, as well as at the high pressure exit, thereby shifting the expansion work (based on the pressure ratios) from the high pressure section to the intermediate pressure section of the steam turbine. A shift in the expansion work of that nature negatively impacts an existing steam turbine design due to the hotter high pressure exhaust temperatures (a result of reduced expansion and corresponding lower temperature drop) and higher intermediate inlet pressures. The design can even cause steam turbine shaft thrust imbalances. Although option 2 in FIG. 3 does not suffer from a significant solar “off” penalty, the system has nevertheless been found to be less efficient than the invention depicted in FIGS. 6 and 7.

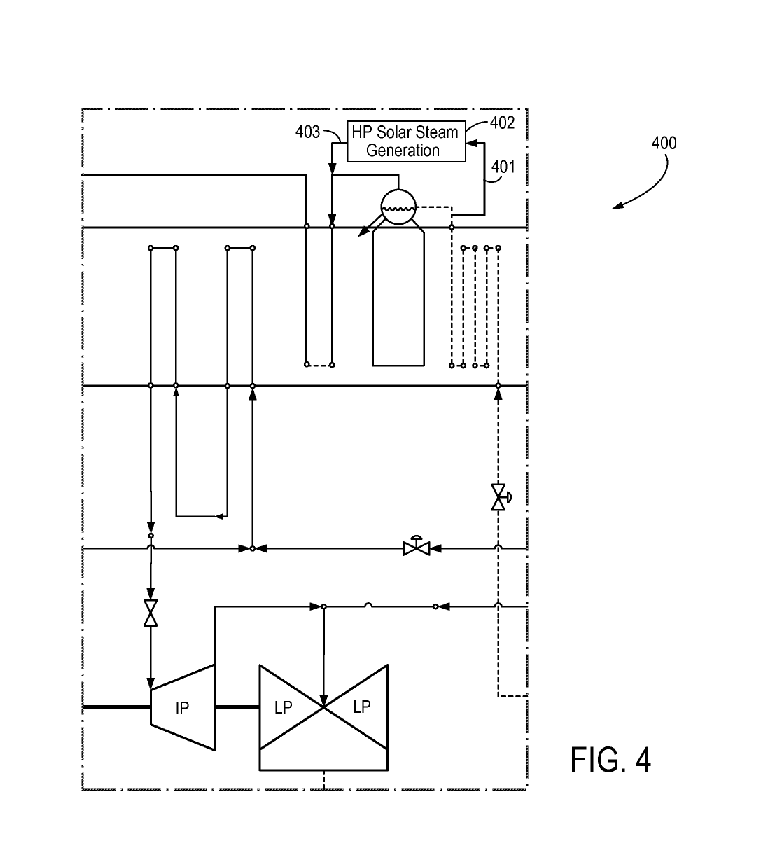

FIG. 4 shows a third portion of the general process flow diagram of FIG. 1 depicting another known option for using steam generated by a solar plant (shown generally as 400). This option exhibits thermal efficiency similar to the present invention when the solar steam generation is “on,” however the option also observes a significant efficiency penalty when the solar steam generation subsystem is “off.” The FIG. 4 option is similar in principle to the cold reheat system illustrated in FIG. 3. However, water is extracted upstream of a high pressure drum and the steam is re-admitted back into the HRSG through one of the high pressure superheaters upstream of high pressure superheater 113. The third option relies on a separate high pressure feed 401 from the high pressure economizer (118 in FIG. 1) which passes into and through solar steam generator 402 resulting in high pressure steam feed 403 that combines with the feed to high pressure superheater 116 (FIG. 1).

The system illustrated in FIG. 4 may be the most thermally efficient of the 3 options discussed above in connection with FIGS. 2, 3 and 4 when the supplemental solar heat subsystem is active. However, unlike the first two options, the FIG. 4 design suffers from a much greater solar “off” performance penalty. In particular, the high pressure throttle pressure becomes a dominating factor in determining the steam turbine and HRSG design (such as impacting shell thickness, bolting design, valve sizing, piping, tube thicknesses, etc). Thus, if the combined cycle steam turbine has been designed for a given high pressure throttle pressure (e.g., assume 1900 psi for illustrative purposes), that pressure defines the maximum operating pressure using high pressure solar steam injection. Thus, if the superheated solar steam contributed, for example, 25% of the overall high pressure steam production, then the design pressure necessarily would drop to approximately 1450 psi when the solar steam is not available. As a result, the plant would be forced to accept the performance penalty associated with the lower overall pressure when operating in a solar “off” condition.

Notably, the same concern does not arise with the second option discussed above. In FIG. 3, when solar steam is not available, the intermediate pressure ratio decreases while the high pressure ratio increases and the high pressure throttle pressure remains constant. Essentially, the pressure ratio shifts from an intermediate to high pressure, but the overall work of the steam turbine remains substantially unchanged.

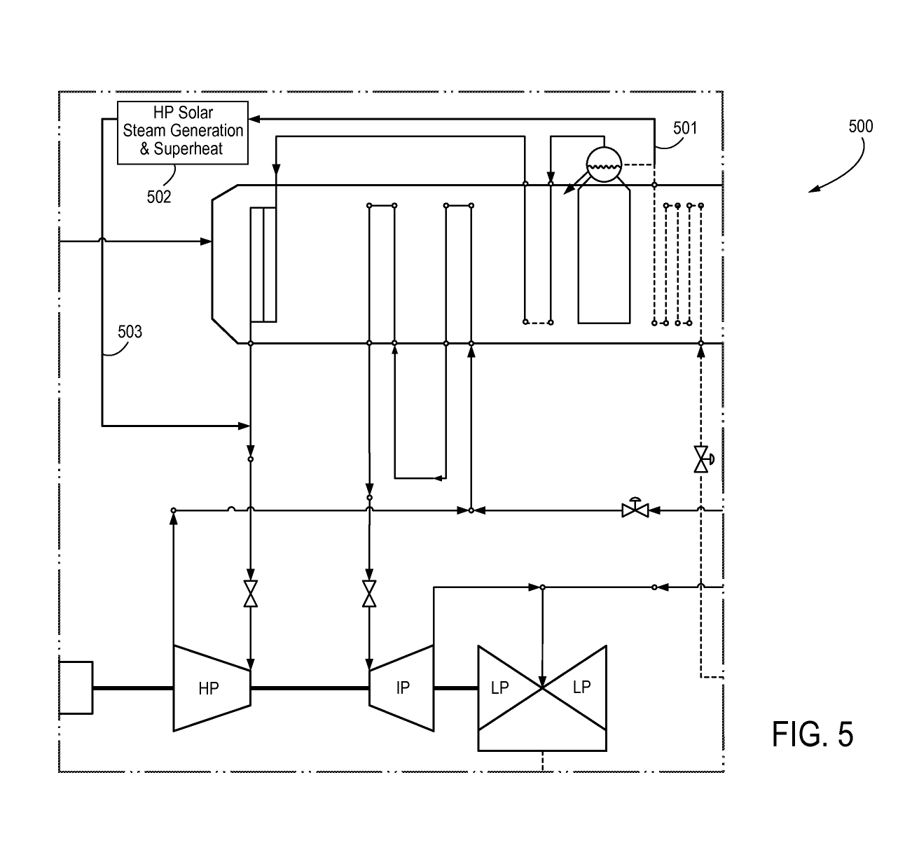

FIG. 5 depicts still another portion of the general process flow diagram for the combined cycle plant in FIG. 1 illustrating a fourth option (identified generally at 500) for using steam generated by a solar plant. Similar to option 3, this option exhibits a thermal efficiency similar to the present invention when the solar steam generation is “on.” However, this option also suffers from a significant efficiency penalty when the solar steam generation subsystem is “off.” FIG. 5 thus shows that under certain conditions it may be possible to feed superheated steam from high pressure solar steam generator 502 (which treats high pressure water feed 501 discharged from high pressure economizer 118) directly into the high pressure section of the steam turbine as shown. The discharge from solar field 503 combines with a feed from high pressure superheater 113 before being fed to high pressure section 107 of the steam turbine.

In essence, FIG. 5 shows that under certain limited process conditions the solar field may introduce a sufficient amount of superheat into the steam to allow it to be fed directly into the high pressure inlet of the turbine. However, this fourth option likewise suffers from a significant thermal efficiency penalty when the solar field is not operating. As the solar field is turned on, the high pressure throttle pressure increases significantly, thereby requiring that the steam turbine itself be increased in size (resulting in much higher equipment and operational costs). When the solar field is off, the throttle pressure drops substantially, again resulting in a significant overall performance penalty to the turbine and the overall plant. As noted below in connection with FIGS. 6 and 7, the present invention substantially avoids the same solar “off” penalty, resulting in a significantly lower cost of electricity (COE) and higher efficiency.

FIG. 6 is a process flow diagram depicting the flow pattern and major pieces of equipment for a first embodiment of the invention, shown generally at 600, using an external solar steam generation plant that results in a significantly higher thermal efficiency for a combined cycle plant. In FIG. 6, high pressure, high temperature water 601 from high pressure economizer 118 feeds into high pressure solar steam generator 602, which in turn feeds superheated steam 603 into and through optional superheater 604. The superheated steam discharge 605 from optional superheater 604 passes directly into one or more intermediate pressure locations on the high pressure section of the steam turbine through control valve 606 via superheated supplemental steam feed 607.

As indicated above, the solar technology used in FIG. 6 (identified generally by solar steam generator 602) comprises one or more modular solar fields that can be retrofitted into an existing combined cycle plant and maximize the solar-based steam production. The system is also scalable to meet a wide range of power generation systems using HRSG configurations with one, two or three pressure levels and with or without reheat. Typically, solar steam generator 602 includes a plurality of sun-tracking heliostats that reflect solar heat to a thermal receiver mounted on top of a central power tower. The focused heat boils water within the thermal receiver to produce the superheated steam. The plant pipes the steam from each thermal receiver and aggregates the superheated steam for feeding into the plant.

The use of superheater 604 in FIG. 6 (see also item 704 in FIG. 7) is considered “optional” in practicing the invention since its use depends, in significant part, on the thermal characteristics of the solar steam being generated and integrated into the combined cycle plant through the HRSG. The physical and thermal characteristics of the additional solar steam in turn depend on the specific type of solar technology involved. For example, certain oil-based solar systems typically cannot provide steam above about 700-750° F. In such cases, the invention contemplates including optional superheater 604 as shown. Other, more recent vintage, technologies have the capability of providing solar steam at higher temperatures and pressures, such as up to about 1,100° F. Thus, optional superheater 604 may not be required but may still be desired in order to accommodate certain operating modes. In addition, the steam generated by the solar unit at such elevated temperatures and pressures may, on occasion, be introduced directly into the high pressure section of the steam turbine.

In the embodiment of FIG. 6, the process step identified as “HP Solar Steam Generation” (item 602) refers to an exemplary solar steam available commercially, such as the systems manufactured by eSolar, Inc. located in Burbank, Calif. eSolar has developed a utility-scale solar power plant that uses small, flat, pre-fabricated mirrors (heliostats) to very accurately track the sun and reflect its heat to a tower-mounted receiver, which in turn generates superheated steam. Literally thousands of systematically spaced heliostats can be aligned and controlled using software algorithms to precisely focus the sun's energy. The heliostats combine to form a modular field, normally comprising north and south facing mirror sub-fields. The mirror fields concentrate sunlight to a thermal receiver mounted above a central tower. The design thereby optically optimizes the layout and maximizes the accumulated thermal energy for use in generating a supplemental steam source.

In FIG. 6, the initial feed to the solar steam generation field (see HP solar steam generator 602) can originate from a number of different sources in the combined cycle plant and still serve to increase the overall thermal efficiency of the system, including, for example, a feed from high pressure economizer 118 in FIG. 1 or from other lower temperature water sources such as the discharge from high pressure boiler feedwater pump 134. As a result, those skilled in the art will appreciate that the need for superheater 604 as shown in FIG. 6 (item 704 in FIG. 7) is considered optional in practicing the invention and depends, in significant part, on the thermal characteristics of the solar steam being integrated into the combined cycle plant. Those physical and thermal characteristics in turn depend on the specific type of solar technology.

Finally, FIG. 7 is a process flow diagram showing the flow pattern and major pieces of equipment for a second exemplary embodiment of the invention (identified generally as 700) which likewise result in thermal efficiencies similar to option 3 when the solar steam generating subsystem is “on,” but avoids the significant efficiency penalty when the solar steam generation subsystem is “off.” This alternative embodiment includes multiple potential feeds from the high pressure solar steam generation, either with or without the optional superheater as described above in connection with FIG. 6. The superheated steam is injected directly into one or more intermediate stages of the high pressure steam turbine. High pressure, high temperature water 701 from high pressure economizer 118 (see FIG. 1) feeds into high pressure solar generator 702 and the resulting superheated steam from solar generator 703 passes through the optional superheater 704 as described above. The supplemental superheated steam 705 from optional superheater 704 then feeds into one or more relevant stages of the high pressure steam turbine at HP steam injection points 708 and 710 using separate steam control valves 711 and 712, respectively.

As noted above, the use of one or more solar generated steam feeds into relevant intermediate stages of high pressure steam turbine 107 has been found to provide operating benefits to the steam turbine and overall combined cycle. In addition, various different operating scenarios exist in which multiple intermediate steam admissions result in significant overall operational benefits. As one example, the embodiment could rely on temperature matching of the solar generated steam to the local interstage temperature either as the outside ambient temperature changes or as the overall combined cycle plant load changes over time.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of designing or retrofitting a combined cycle power plant to integrate a supplemental steam source generated by solar radiation, said combined cycle power plant including a gas turbine engine and heat recovery steam generator (HRSG), said method comprising the steps of:
providing a solar steam generation subsystem to capture and transfer heat using solar radiation to produce a supplemental superheated steam source;
providing a steam turbine operatively connected to said gas turbine; and
injecting a portion of said supplemental superheated steam formed by solar radiation into an intermediate stage of the high pressure section of said steam turbine.

2. A method according to claim 1, further comprising the step of forming superheated steam inside said HRSG for injection into said steam turbine separately from said supplemental superheated steam formed by solar radiation.

3. A method according to claim 1, wherein said step of providing a steam turbine results in a steam turbine sufficient in size to utilize all superheated steam produced by said HRSG and by said solar steam generation subsystem when operating at full capacity.

4. A method according to claim 1, wherein the throttle pressure of said high pressure section of said steam turbine remains substantially the same when the solar steam generation subsystem is either active or inactive.

5. A method according to claim 1, wherein said solar steam generation subsystem provides a thermal efficiency benefit and avoids an efficiency penalty when said subsystem is “off.”

6. A method according to claim 1, further comprising the steps of feeding said supplemental superheated steam formed by solar radiation into and through the HRSG and thereafter feeding superheated steam to an intermediate stage of the high pressure section of said steam turbine.

7. A method according to claim 1, wherein said steam turbine comprises high, intermediate and low pressure steam injection subsections.

8. A method according to claim 1, wherein said step of injecting a portion of said supplemental superheated steam formed by solar radiation is carried out with either one, two or three steam pressure levels and with or without reheat operating in said HRSG.

9. A method according to claim 1, wherein said HRSG operates using at least one evaporator, one or more steam superheaters and one or more economizers.

10. A method according to claim 1, wherein said step of injecting said supplemental superheated steam formed by solar radiation further comprises the step of dividing said supplemental superheated steam into one or more substreams for injection into corresponding separate middle stages of said high pressure section of said steam turbine or the exhaust from said high pressure section.

11. A combined cycle gas and steam power plant comprising:
a gas turbine unit;
a generator;
a heat recovery steam generator (HRSG) for producing superheated steam using heat transferred from a high temperature exhaust gas;
a steam turbine operatively connected to said HRSG;
a separate solar steam generation subsystem integral with said HRSG for producing an additional amount of high pressure superheated steam;
a heat transfer medium for producing high pressure superheated steam; and
high pressure steam injection means for injecting superheated steam from said solar generation unit into one or more middle stages of the high pressure section of said steam turbine.

12. A combined cycle gas and steam power plant according to claim 11, further comprising steam injection means for injecting said superheated steam formed by solar radiation into the one or more intermediate stages of the high pressure section of said steam turbine.

13. A combined cycle gas and steam power plant according to claim 11, wherein said steam turbine is sufficient in size to utilize all superheated steam produced by said HRSG and by said solar steam generation subsystem when operating at full capacity.

14. A combined cycle gas and steam power plant according to claim 11, wherein the throttle pressure of said high pressure section of said steam turbine remains substantially the same when said solar steam generation subsystem is either active or inactive.

15. A combined cycle gas and steam power plant according to claim 14, wherein said solar steam generation subsystem provides a thermal efficiency benefit and avoids an efficiency penalty when said subsystem is “off.”

16. A combined cycle gas and steam power plant according to claim 11, further comprising solar steam injection means for feeding said superheated steam formed by solar radiation into one or more middle stages of said high pressure section of said steam turbine.

17. A combined cycle gas and steam power plant according to claim 11, wherein said steam turbine comprises high, intermediate and low steam pressure subsections.

18. A combined cycle gas and steam power plant according to claim 11, further comprising feed separation means for dividing said high pressure superheated steam into one or more streams for injection into corresponding middle stages of said high pressure steam turbine.

19. A combined cycle gas and steam power plant according to claim 11, wherein said HRSG comprises one or multiple steam reheating sections.

20. A combined cycle gas and steam power plant according to claim 11, wherein said HRSG comprises at least one evaporator, one or more steam superheaters and one or more economizers.
